(19) United States
(12) Patent Application Publication
(10) Pub. No.: US 2005/0250480 A1
(43) Pub. Date: Nov. 10, 2005

(54) System and method of managing communication network-dedicated architecture on a terminal

(76) Inventor: Etienne Annic, Rambouillet (FR)

Correspondence Address: Thomas Langer;Cohen Pontani Lieberman & Pavane, Suite 1210, 551 Fifth Avenue, New York, NY, 10176, US

(21) Appl. No.: 10/517,860

(22) PCT Filed: Jun. 13, 2003
(86) PCT No.: PCT/FR03/01807

§ 371 Date: Dec. 14, 2004

(30) Foreign Application Priority Data
Jun. 17, 2002 (FR) 02/07457

(51) Int. Cl. H04Q 7/20

(52) U.S. Cl. 455/414.1; 455/403

(57) ABSTRACT

System for managing at least one architecture (15, 16, 17, 18) of a terminal (10) dedicated to a communications network (40, 41, 42, 50, 51, 52). The terminal (10) includes at least one user interface (11). Connections to the communications network are set up via a mobile network. The system comprises at least one dedicated architecture manager (24) integrated into the terminal (10), adapted to manage at least one architecture dedicated to a communications network and adapted to process simultaneously the operation of the communications networks. This technique enables simultaneous management of access to a plurality of communications networks offering a set of services from a terminal connected to a public mobile network to which the user is a subscriber.

The present invention relates to a system and method for managing on a terminal an architecture dedicated to a communications network.

The invention applies more particularly to the simultaneous management of access to a plurality of communications networks offering a set of services from a terminal connected to a public mobile network to which the user is a subscriber.

At present such services are accessible from a terminal connected to mobile telecommunications networks such as General Packet Radio Service (GPRS) networks and Universal Mobile Telecommunication System (UMTS) networks.

In these mobile networks, in order to select a communications network offering services, it is necessary to select a name identifying said communications network. To set up a connection between a terminal and a particular communications network, said name is sent via a service support equipment of the mobile network to an equipment managing access to said communications networks. Coming from the terminal, said name enables said service support equipment of the mobile network to determine the access management equipment associated with said identifying name that offers access to the communications network.

In existing GPRS and UMTS networks, the name identifying a communications network is called its access point name (APN), the service support equipment is called the serving GPRS support node (SGSN), and the equipment managing access to the various communications networks is called the gateway GPRS service node (GGSN).

An APN primarily comprises an identifier corresponding to the selected communications network, an identifier of the carrier or “operator” that manages said communications network, and an identifier of the technology of the mobile network, for example the GPRS technology. The format and use of an APN are standardized by the European Telecommunications Standards Institute (ETSI).

One function of an SGSN is to receive an APN from a terminal and send it to the APN server to which it is connected in order for it to be recognized. Said APN server responds by sending the SGSN a list of the GGSN associated with the APN. One function of said SGSN is to set up a connection to a GGSN from said list. Said GGSN then sets up the connection to a communications network corresponding to the APN. The SGSN and the GGSN are also standardized by the ETSI.

To access a communications network offering a set of services, the user selects an APN on the terminal in order to set up a connection with the corresponding communications network.

When an APN has been selected on the terminal, an access protocol is started up. On a GPRS or UMTS network, this protocol is called the packet data protocol (PDP). A procedure for setting up the connection from the terminal to the GGSN is executed. A link across the mobile network to the selected communications network is created to enable setting up of the connection. In a GPRS or UMTS network, this link is called the “PDP Context” and provides access from the terminal to all the services of said communications network.

At the end of this procedure, the terminal receives from the communications network with which the connection has been set up an address that identifies said terminal within said communications network and is associated with the PDP context linking the terminal and said communications network.

At present, a terminal manages only one connection to a communications network at a time. It receives only one address at a time, associated with a PDP Context and coming from a single communications network.

In this configuration, all of the architecture of the terminal is dedicated to the operation of said terminal connected to said communications network.

Each communications network is independent of the other communications networks and has its own addressing scheme. Because of this, a communications network A does not know what is being done by a communications network B. In particular, the communications network A does not know to which terminal the communications network B is connected. Similarly, said communications network A does not know what address the communications network B sends in order to identify the connected terminal.

The ETSI standard provides for a plurality of connections from the same terminal to different communications networks to be set up simultaneously.

In this case, said terminal must create a plurality of PDP Contexts simultaneously to set up a connection to a plurality of communications networks.

An address coming from each of said communications networks for identifying said terminal is associated with each of these PDP contexts.

On access from the terminal to two communications networks A and B, two PDP Contexts and the two addresses received are managed by said terminal.

Consequently, the two PDP Contexts providing access to the two communications networks are linked via said terminal. In this configuration, the two communications networks are no longer independent, since a physical connection between them has been set up via said terminal.

Addressing problems in the case of identical addresses assigned for different networks and confidentiality, security, and piracy problems are then encountered in relation to the information transmitted by the services provided by the various communications networks. These problems are particularly sensitive when using a banking service, for example, or when accessing a private company intranet via a communications network.

Thus the technical problem to be solved by the present invention is that of providing a system and a method of managing on a terminal at least one architecture dedicated to a communications network that remedy the drawbacks of existing systems by reorganizing the terminal structure in such a way as to avoid any link between the connections to a plurality of communications networks.

The solution in accordance with the present invention to the technical problem as stated consists in that, connections to said communications network being set up via a mobile network, said system comprises at least one dedicated architecture manager integrated into said terminal, adapted to manage independently at least one architecture dedicated to a communications network, and adapted to process simultaneously the operation of said terminal when connected to a plurality of said communications networks.

On setting up the connection to a communications network, the dedicated architecture manager dialogues with said communications network. Said dedicated architecture manager designates an architecture that is dedicated to the connection to said communications network.

On setting up each new connection to a new communications network, the dedicated architecture manager designates a different architecture to be dedicated to the connection to said new communications network.

In the same terminal, the various dedicated architectures, each providing access to a different communications network, function simultaneously.

According to the invention, each of said architectures dedicated to a communications network comprises at least one network interface whose parameters are set by an address for identifying said terminal in said communications network that is sent by said dedicated architecture manager and comes from said communications networks.

Each network interface is included in a different dedicated architecture. There is therefore no longer any relation between the PDP contexts that have been set up to the various communications networks.

Each communications network communicates with a dedicated architecture of said terminal via a separate network interface. The address sent by each of the communications networks is received by said dedicated architecture manager and its parameters are set at a network interface. A network interface of a dedicated architecture does not relate to any other network interface of any other dedicated architecture.

According to the invention, each architecture dedicated to a communications network is independent of the other dedicated architectures of said terminal.

Despite the simultaneous operation of a plurality of dedicated architectures on the same terminal, there is no link between the various communications networks. The structure of the terminal is such that said dedicated architectures are not related to each other. They operate separately and autonomously.

Because of this, by virtue of the various dedicated architectures, said terminal may operate differently according to the communications network to which it is connected. For example, functions may be handled by one communications network that do not exist on another communications network.

Moreover, because of the increase in the number of services accessible via communications networks, the autonomy of each dedicated architecture in particular enables specific resources to be assigned that differ from one communications network to another, for example specific applications, a different memory space, or different qualities of service.

According to the invention, said user interface of the terminal provides access to at least one architecture dedicated to one communications network.

The user interface of said terminal, for example a display, audio means, voice signal transmission means or a Braille reader, provides access to the services corresponding to a communications network. Given the different architectures that are dedicated to different communications networks, a plurality of services may be used simultaneously on said terminal.

The invention further consists in a method of managing on a terminal at least one architecture dedicated to a communications network, said terminal including at least one user interface, which method is characterized in that, connections to said communications networks being set up via a mobile network, said method includes the steps of: setting up a connection between said terminal and at least one communications network via said mobile network in at least one dedicated architecture manager, receiving at least one address coming from said communications network connected to said terminal in said dedicated architecture manager of said terminal, said dedicated architecture manager in said terminal selecting a dedicated architecture for said communications network, sending said address to said dedicated architecture selected by said dedicated architecture manager, setting parameters of said address at a network interface in said architecture dedicated to said communications network, accessing at least one dedicated architecture via said user interface of said terminal, setting up by means of said dedicated architecture manager at least one simultaneous connection to a plurality of communications networks, processing the simultaneous management of a plurality of communications networks connected to said terminal.

The various steps of the method according to the invention are repeated each time said terminal is connected to a new communications network.

Said dedicated architecture manager manages each connection to a communications network.

It assigns a dedicated architecture to each of said communications networks, which makes it possible to use different and independent management methods at the same time.

The following description with reference to the appended drawing, which is provided by way of non-limiting example, explains in what the invention consists and how it may be put into practice.

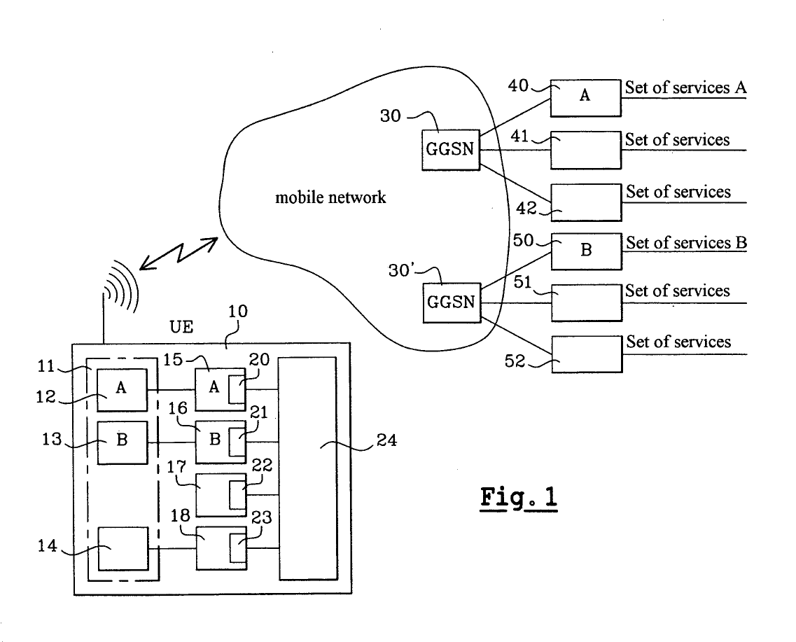

FIG. 1 is a diagram of the general architecture of a system according to the invention, as implemented on a terminal, for managing an architecture dedicated to a communications network.

To facilitate an understanding of the invention, it is described using UMTS terminology. However, the invention applies to all communication systems using identical techniques to identify a communications network.

Similarly, to simplify the description, the mobile telecommunications network subscriber is indicated as a terminal 10, but may be of various kinds, for example a server or a mobile communication terminal, a personal computer (PC) or a television, and takes the form of a user equipment (UE) 10 in FIG. 1.

Whatever type of terminal 10 is used, it is connected to a public mobile network to which the user is a subscriber.

If the terminal 10 wishes to access a first communications network 40, 41, 42 offering a set of services which said terminal 10 wishes to access, it transmits an APN identifying said communications network 40, 41, 42 via a radio station of the mobile network.

In said mobile network, an SGSN receives said APN from said terminal 10 and determines which GGSN manages said APN.

The SGSN sends the APN to an APN server to which it is connected and which holds a table of correspondences between APN and GGSN, and selects a GGSN 30 which manages said APN.

Said GGSN 30 sets up the connection to said first communications network 40, 41, 42. A first PDP Context is set up to said first communications network 40, 41, 42 through the mobile network. This first PDP Context enables the terminal 10 to access the first communications network 40, 41, 42.

As a function of the mobile network, for GPRS or UMTS technologies, if a user accesses a plurality of services in the same communications network, a plurality of simultaneous calls to said communications network, known as secondary PDP Contexts, are set up.

In this case, the various secondary PDP Contexts are associated with the same primary PDP Context, which operates in exactly the same way as described hereinabove for a PDP Context, which is the term used in the remainder of the description.

Said first communications network 40, 41, 42 then sends the terminal 10 an address Al which identifies said terminal 10 for said first communications network connected.

The dedicated architecture manager 24 in said terminal 10 receives said address Al, assigns a first dedicated architecture 15 to said first communications network 40, 41, 42 connected, and sends the address Al to a first network interface 20 in said first architecture 15 dedicated to said first communications network 40, 41, 42 connected.

Said first dedicated architecture 15 is associated with said first PDP context, which enables access from said terminal 10 to said first communications network 40, 41, 42.

When said terminal 10 wishes to access a second communications network 50, 51, 52, it transmits a second APN and the same connection process is repeated via the equipments referred to above (the SGSN and the GGSN 30).

A new connection is set up between said terminal 10 and a second communications network 50, 51, 52. Consequently, a second PDP Context is set up via said mobile network to said second communications network 50, 51, 52.

A new address A2 that identifies said terminal 10 for said second communications network 50, 51, 52 is sent to the terminal 10.

In said terminal 10, said dedicated architecture manager 24 receives the new address A2. It assigns a second architecture 16 to said second communications network 50, 51, 52 connected and sends the address A2 to a second network interface 21 in said second architecture 16 dedicated to said second communications network connected.

From this point onwards, said second dedicated architecture 16 is associated with said second PDP Context, which enables access from said terminal 10 to said second communications network 50, 51, 52.

Thus, in said terminal 10, an independent architecture 15, 16, 17, 18 is dedicated to each communications network 40, 41, 42, 50, 51, 52 to which said terminal 10 is connected. The parameters of each address received from a different communications network are therefore set at a different network interface 20, 21, 22, 23 in an architecture 15, 16, 17, 18 dedicated to a communications network 40, 41, 42, 50, 51, 52.

In the same way, each network interface 20, 21, 22, 23 is identified by only one address to guarantee that the data transmitted between a communications network 40, 41, 42, 50, 51, 52 and said terminal 10 reaches the correct destination.

According to the technologies of the communications networks, and in conformance with the standard, the address sent may have various formats, for example an Internet Protocol (IP) version 4 or version 6 address. These formats and versions are standardized by the Internet Engineering Task Force (IETF).

Whatever the format, the addressing version or type, for example point-to-point protocol (PPP) addressing or any other type of addressing that may be developed in the future, the transmission of the address between a communications network and said terminal 10 remains the same. The architecture of said terminal 10 facilitates adaptation to the various generations.

With this structure, for a terminal 10, each dedicated architecture and its network interface are independent of each of the dedicated architectures 15, 16, 17, 18 of said terminal 10.

Each architecture 15, 16, 17, 18 dedicated to a communications network 40, 41, 42, 50, 51, 52 receives all the information coming from said communications network 40, 41, 42, 50, 51, 52 associated with said dedicated architecture 15, 16, 17, 18 via the PDP context corresponding to said communications network 40, 41, 42, 50, 51, 52.

Once the connection has been set up, the dedicated architecture accesses the user interface 11 of said terminal 10. Thus the subscriber accesses at least one service content of a first communications network 40, 41, 42, for example a home page 12.

If the subscriber selects on said terminal 10 access to a second communications network 50, 51, 52, the content corresponding to a new service 13 provided by said second communications network 50, 51, 52, for example a new home page 13, is accessible via said user interface 11.

Depending on the capabilities of the operating system of said terminal 10, a plurality of windows may be displayed offering the various home pages 12, 13, 14 of the various communications networks, or the user may switch from one home page to another using a selection device such as a button or a touch-sensitive control on said terminal 10.

If the communications network does not require the display of the content on said terminal 10, the content from said communications network may be represented by any other means provided by the user interface 11 of said terminal 10, such as by means of a voice message reproduced by audio means.

Each dedicated architecture 15, 16, 17, 18 controls access to existing means of said terminal 10 allowing use of the services of a communications network, for example a picture or video player, a browser for surfing the World Wide Web, etc.

The system and method of the invention provide for separate and autonomous management of a plurality of connections to a communications network in the same terminal 10 via said dedicated architecture manager 24.

A PDP Context is associated with only one communications network, which sends only one address to a single network interface to identify said terminal 10.

In this way, each network interface is associated with only one address coming from a communications network. In a communications network, a given address is sent to only one network interface.

This principle of unique addressing between a network and a network interface enables the error-free transmission of data to the correct destination, from said terminal 10 to a communications network 40, 41, 42, 50, 51, 52 and vice-versa.

The autonomy and independent operation of the various dedicated architectures 15, 16, 17, 18 on said terminal 10 guarantee compliance with the principle of unique addressing when accessing a plurality of communications networks 40, 41, 42, 50, 51, 52.

Each communications network is independent and has its own addressing scheme. Consequently, two communications networks may transmit the same address to the terminal 10.

No violation of the principle of unique addressing occurs when the architecture of said terminal 10 conforms to the invention, because the two independent network interfaces that receive the two identical addresses are connected to two different communications networks, which remain independent. Each architecture is autonomous and dedicated to a different communications network.

In this case, the same addressing scheme may be used by more than one communications network 40, 41, 42, 50, 51, 52. Unique addressing is preserved in said terminal 10. This is one way to solve the problem of a lack of available addresses, for example on Internet Protocol (IP) networks.

Even if the addressing scheme is not exactly the same for two different communications networks, independent management of the dedicated architectures 15, 16, 17, 18 ensures confidentiality and security between said communications networks 40, 41, 42, 50, 51, 52. The requirement for confidentiality and security applies to a banking transaction or a connection to a private business network, for example.

Each PDP context is managed by a different dedicated architecture unrelated to the other architectures 15, 16, 17, 18 dedicated to a communications network 40, 41, 42, 50, 51, 52.

Because of the separate management of the communications networks 40, 41, 42, 50, 51, 52 by the dedicated architectures 15, 16, 17, 18, this structure provides a seal between the various services connected to said terminal 10 and prevents pirating of information transmitted by a service of a first communications network from a second communications network, for example a network connected to the Internet.

Moreover, the independent processing of each communications network 40, 41, 42, 50, 51, 52 by a different dedicated architecture 15, 16, 17, 18 in the same terminal improves the adaptation to each communications network.

Different qualities of service could be managed simultaneously on the same terminal 10. For example, a first network might have good transmission quality and a second network a lower transmission quality. A third network might have a high error rate.

All functions and evolutions of the communications networks may also be managed independently by each of the architectures 15, 16, 17, 18 on the same terminal 10 dedicated to a communications network 40, 41, 42, 50, 51, 52.

1. A system for managing a set of architectures (15, 16, 17, 18) of a terminal (10) dedicated to a Plurality of communications networks (40, 41, 42, 50, 51, 52), said terminal (10) including at least one user interface (11), which system is characterized in that, connections to said communications networks being set up via a mobile network, said system comprises at least one dedicated architecture manager (24) integrated into said terminal (10), adapted to manage independently all of said architectures dedicated to a said communications networks (40, 41, 42, 50, 51, 52), adapted to process simultaneously the operation of said terminal (10) when connected to a plurality of said communications networks, adapted to manage separately simultaneous connections with a plurality of said communications networks, and adapted to manage independently a plurality of said communications networks after receiving a non-unique address from each of said networks connected to the terminal (10).

2. A system according to claim 1 for managing a set of dedicated architectures (15, 16, 17, 18) of a terminal (10), characterized in that each of said architectures (15, 16, 17, 18) dedicated to one of said communications networks (40, 41, 42, 50, 51, 52) comprises at least one network interface (20, 21, 22, 23) whose parameters are set by an address for identifying said terminal (10) in said communications networks (40, 41, 42, 50, 51, 52) that is sent by said dedicated architecture manager and comes from said communications networks (40, 41, 42, 50, 51, 52).

3. A system according to claim 1 or managing a set of dedicated architectures (15, 16, 17, 18) of a terminal (10), characterized in that each of said architectures (15, 16, 17, 18) dedicated to one of said communications networks (40, 41, 42, 50, 51, 52) is independent of the other dedicated architectures (15, 16, 17, 18) of said terminal (10).

4. A system according to claim 1 for managing at a set of dedicated architectures (15, 16, 17, 18) of a terminal (10), characterized in that said user interface (11) of the terminal (10) provides access to at least one architecture (15, 16, 17, 18) dedicated to one of said communications networks (40, 41, 42, 50, 51, 52).

5. A dedicated architecture manager (24) in a terminal (10) associated with a dedicated architecture management system according to claim 1, which manager is characterized in that it comprises at least transceiver means for communicating with at least one of said communications networks (40, 41, 42, 50, 51, 52), processing means for managing simultaneous access to said plurality of communications networks by said terminal (10), means for selecting an architecture (15, 16, 17, 18) dedicated to one of said communications networks, and transmission means with at least one dedicated architecture of said terminal (10).

6. A method of managing on a terminal (10) a set of dedicated architectures (15, 16, 17, 18) dedicated to the plurality of communications networks (40, 41, 42, 50, 51, 52), said terminal (10) including at least one user interface (11), which method is characterized in that, connections to said communications networks being set up via a mobile network, said method includes the steps of:
setting up a connection between said terminal (10) and the plurality of communications networks via said mobile network in at least one dedicated architecture manager (24),
receiving at least one address coming from each of said communications networks connected to said terminal in said dedicated architecture manager (24) of said terminal (10),
said dedicated architecture manager (24) in said terminal (10) selecting a dedicated architecture for each of said communications networks,
sending said address to said dedicated architecture selected by said dedicated architecture manager (24),
setting parameters of said address at a network interface (20, 21, 22, 23) in said architectures dedicated to said communications networks,
accessing at least one dedicated architecture via said user interface (11 ) of said terminal (10),
setting up and managing separately by means of said dedicated architecture manager (24) at least one simultaneous connection to said plurality of communications networks,
processing the independent management of all said architectures (15. 16 17. 18) dedicated to said communications networks,
processing the simultaneous management of a plurality of communications networks connected to said terminal (10) and.
independently managing a plurality of said communications networks after receiving a non-unique address from each of said networks connection to said terminal.
